(19) United States
(12) Patent Application Publication
(10) Pub. No.: US 2007/0272673 A1
(43) Pub. Date: Nov. 29, 2007

(54) Electric mattress and mattress pad

(76) Inventor: Barry P. Keane, Clemson, SC (US)

Correspondence Address: SUSAN F. JOHNSTON, PO BOX 4449, JOHNSON CITY, TN, 37602, US

(21) Appl. No.: 11/543,013

(22) Filed: Oct. 3, 2006

Related U.S. Application Data
(63) Continuation-in-part of application No. 10/910,102, filed on Aug. 2, 2004, now Pat. No. 7,115,842.
Application No. 10/910,102 is a division of application No. 09/942,517, filed on Aug. 29, 2001, now Pat. No. 6,770,854.

(51) Int. Cl. A47C 21/00; F24D 15/00; H05B 3/00

(52) U.S. Cl. 219/212; 219/217; 5/421

(57) ABSTRACT

Disclosed herein is an electric mattress and an electric mattress pad and other such spreads. The invention preferably includes a regulator system wherein the current supplied to the heating element of the mattress or mattress pad is a function of the resistance associated with the heating element.

### BACKGROUND OF THE INVENTION

This is a continuation-in-part of U.S. application Ser. No. 10/910,102 (now U.S. Pat. No. 7,115,842) which is a division of U.S. application Ser. No. 09/942,517 filed Aug. 29, 2001 (now U.S. Pat. No. 6,770,854), the entire disclosure of which is incorporated by reference herein.

The present invention relates generally to electric blankets, other electric spreads, electrically heated mattresses, electric mattress pads, electric quilts. More particularly, the present invention relates to heated mattresses, mattress covers, mattress pads, mattress pillow-tops, quilts, blankets, and combinations thereof.

Electric blankets typically include a heating element that extends through the blanket and through which electric current passes to generate heat. The heating element is disposed within passageways formed in the weaving process.

While not used in electric blankets, scrim laminate blankets tend to be very comfortable. FIG. 1 shows a prior art scrim laminate blanket 10. Blanket 10 includes a scrim layer 12 sandwiched between a pair of foam layers 14. As should be understood in this art, scrim is an open weave or knit fabric, typically of synthetic yarn, used primarily to improve the structural integrity of a blanket assembly. During manufacturing, a laminating line typically draws the scrim layer and foam layer together adjacent to a flame, thereby bonding the layers together so that a foam layer covers both sides of the scrim layer. From the laminating line, a flocking range applies oriented fibers 16 to one side of the blanket. An additional pass in the flocking range applies the oriented fibers to the other side of the blanket.

The present invention recognizes and addresses disadvantages of prior art constructions and methods.

The accompanying drawings, which are incorporated in and constitute a part of the specification, illustrate one or more embodiments of the invention and, together with the description, serve to explain the principles of the invention.

### SUMMARY OF THE INVENTION

The present invention is a mattress pad, said mattress pad comprising: an elongated heating element strand extending through said mattress pad so that, upon receiving electric current from a power source, said element heats said mattress pad; and a regulator circuit in communication with said heating element electrically between said power source and said heating element, wherein said regulator circuit is configured to measure rate of change in said heating element of at least one of said heating element's resistance and said heating element's current and to control delivery of electricity from said power source to said heating element responsively to said rate of change.

Another aspect of the present invention is an electric mattress, comprising: a mattress core having an upper surface; an elongated heating element extending across the upper surface of said mattress core in a pattern and configured to generate resistive heat upon receiving electric current from a power source thereby forming a heating layer above said mattress core; a regulator circuit in communication with said heating element electrically between said power source and said heating element, wherein said regulator circuit is configured to measure rate of change in said heating element of at least one of said heating element's resistance and said heating element's current and to control delivery of electricity from said power source to said heating element responsively to said rate of change so as to provide heat to said sleeping surface; an insulating layer of fill material disposed above said heating layer; and a fabric cover enveloping said mattress core, said heating layer, and said insulating layer together and defining a channel adapted for providing electrical communication between said power source and said heating element.

### BRIEF DESCRIPTION OF THE DRAWINGS

A full and enabling disclosure of the present invention, including the best mode thereof directed to one of ordinary skill in the art, is set forth in the specification, which makes reference to the appended Figures, in which:

FIG. 1 illustrates a side cross-sectional view of a prior art scrim laminate blanket;

FIG. 2A illustrates a side cross-sectional view of a blanket according to an embodiment of the present invention;

FIG. 2B illustrates a top cross-sectional view of the blanket as in FIG. 2A;

FIG. 3 illustrates a side cross-sectional view of a blanket according to an embodiment of the present invention;

FIG. 4 illustrates a top cross-sectional view of a blanket according to an embodiment of the present invention;

FIG. 5 illustrates a top view of a blanket according to an embodiment of the present invention;

FIG. 6 illustrates a top cross-sectional view of a blanket according to an embodiment of the present invention;

FIG. 7 illustrates a top view of a blanket according to an embodiment of the present invention;

FIG. 8 illustrates a top cross-sectional view of a blanket according to an embodiment of the present invention;

FIG. 9 illustrates a top cross sectional view of a heating element disposed in a blanket according to an embodiment of the present invention;

FIG. 10 illustrates a top view of a blanket according to an embodiment of the present invention;

FIG. 11 illustrates a top cross-sectional view of a blanket according to an embodiment of the present invention;

FIG. 12 illustrates a schematic diagram of the electronic control circuit of a spread according to an embodiment of the present invention;

FIG. 13 is a schematic illustration of a method of making an electric mattress pad according to an embodiment of the present invention.

FIG. 14 illustrates an exploded side cross-sectional view of the electric mattress according to an embodiment of the present invention.

FIG. 15 illustrates another side cross-sectional view of the electric mattress according to an embodiment of the present invention.

### DETAILED DESCRIPTION

Reference is made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can by made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

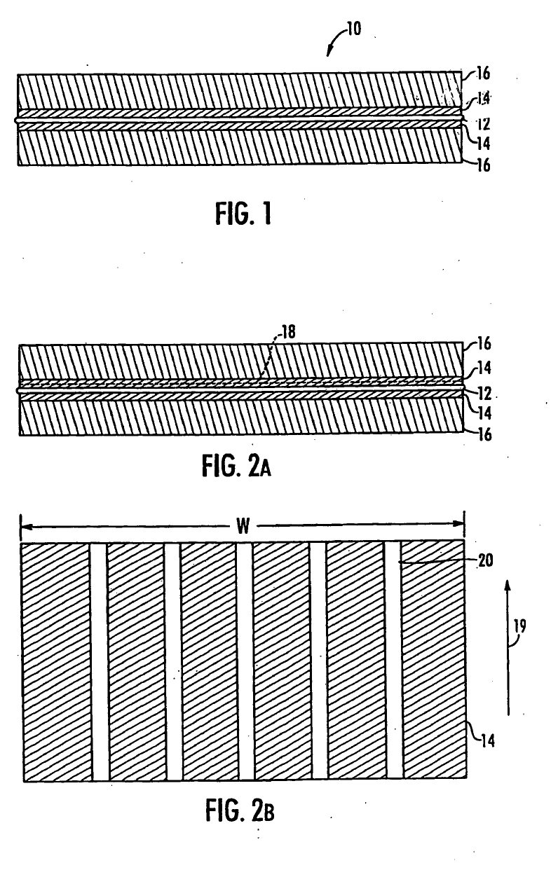

Several preferred embodiments of electric blanket construction described herein include a heating element disposed in a laminated scrim blanket. The process of making a conventional scrim laminate blanket as shown in FIG. 1 should be understood in this art. Generally, a scrim layer and two foam layers on either side of the scrim layer are fed into a lamination machine that laminates the three layers together. Alternatively, the foam layers may be bonded to the scrim layer in successive steps.

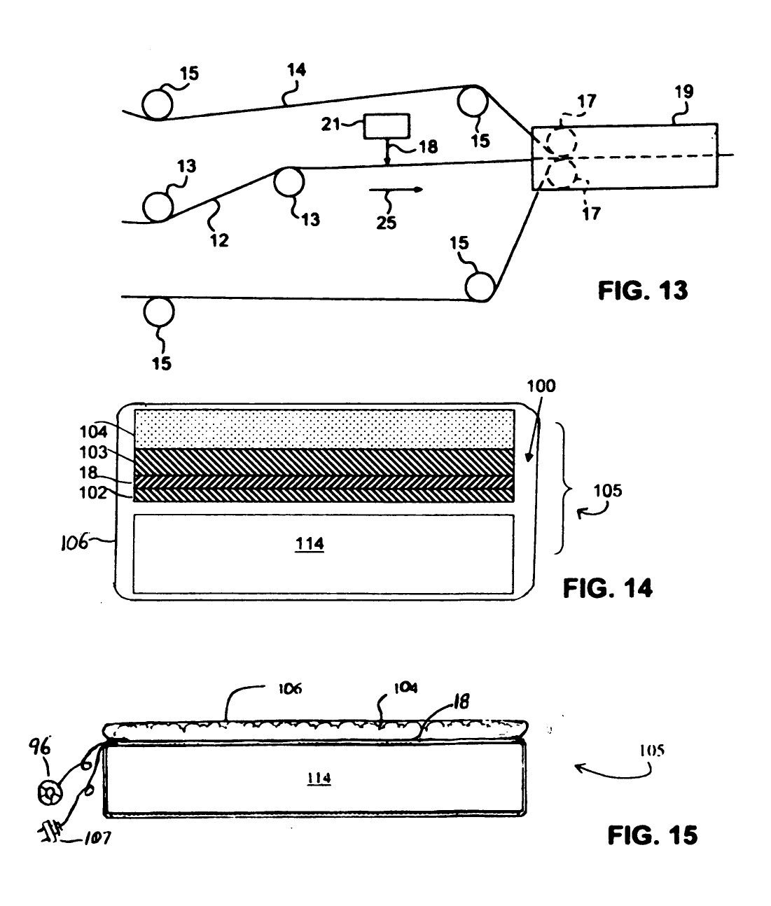

In one preferred embodiment of the present invention, a heating element is disposed on one side of the scrim layer prior to it's lamination to the foam layer on that side. Referring to FIG. 13, a scrim layer 12 and two foam layers 14 are fed from respective rollers 13 and 15 to a flame lamination machine 19. Upon entering machine 19, a flame heats the layers so that they become sticky and nearly melt. Pinch rollers 17 in the machine then press the layers firmly together. Upstream from machine 19, a wire dispenser 21 deposits heating element wire 18 onto the upper surface of scrim layer 12. The dispenser moves reciprocally (in a direction into and out of the page) transversely across the scrim layer as it moves in the direction indicated by arrow 25 toward the lamination machine, thereby depositing the heating element in a serpentine pattern on the scrim. The element, sandwiched between the scrim layer and foam layer following rollers 17, is fixed between the layers by lamination machine 19. In another embodiment, the lower foam layer is added to the underside of scrim layer 12 by a second lamination machine downstream from machine 19.

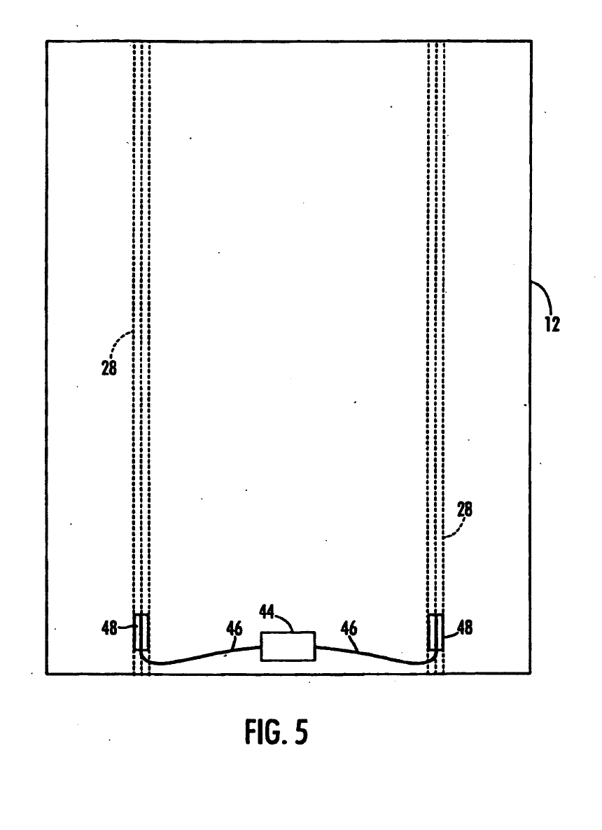

Referring to FIGS. 2A and 2B, another preferred electric blanket includes a heating element 18 disposed within parallel passageways 20 formed between scrim layer 12 and one of the foam layers 14. An electrical plug (such as described below with respect to FIG. 5) connects the heating element to an electrical power supply. Heating element 18 generates resistive heat responsive to the power supply.

The lamination process forms passageways 20 (FIG. 2B) between the scrim layer and one of the foam layers. As should be understood in this art, a lamination machine includes a series of flame jets extending across the width W of the blanket as the blanket passes below the jets in a direction indicated by arrow 19. To form passageways 20, flame jets are deactivated at positions corresponding to each passageway so that the lamination bond is not formed at these positions as the blanket moves in direction 19. Passageways may be formed in a direction transverse to that shown in FIG. 2B by periodically disabling the entire flame as the blanket passes through the lamination process. After forming the scrim/foam laminate, a flocking range adds oriented fiber layers 16 to each side of the laminate.

The blanket material is cut into sections, and a rod feeds the heating element through successive passageways in each blanket section. Any suitable tool or machine, for example as described below, may be used to run the heating element through the passageways. Bindings (not shown) sewn to the blanket ends cover the exposed heating element at the passageway openings. An electrical plug (not shown) connects the ends of the heating element to a power cord and a control circuit as described below.

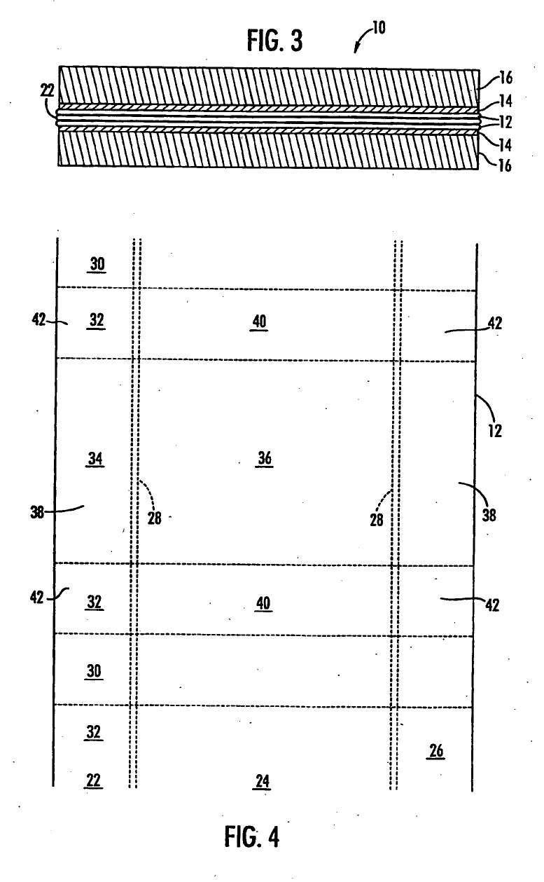

FIG. 3 schematically illustrates an electric blanket having a heating element layer 22 disposed between a pair of scrim layers 12. Each scrim layer 12 is initially formed with a foam layer 14 laminated on only one side. After forming each scrim/foam laminate, a flocking range applies oriented fiber layers 16 to each foam layer. As described in more detail below with respect to FIG. 9, a wire dispenser disposed at the output of the lamination machine moves back and forth across the path of one of the laminate layers and deposits heating element wire on the layer's exposed scrim side. The two layers are then brought together so that wiring layer 22 is sandwiched between the two scrim layers, which are attached to each other by glue, heat seal, edge binding, or other suitable means, to form the blanket. In particular, adhesive or heat seal attachment holds the heating element in place between the scrim layers.

While the above examples include a scrim/foam construction, it should be understood that the present invention may include other suitable arrangements. For example, a wired scrim layer may be sandwiched between woven layers bonded to the scrim by adhesive or acrylic.

FIG. 4 illustrates one method of forming an electric blanket so that the heating element is woven into the blanket itself. A loom outputs a continuous sheet in which warp fibers run in three parallel longitudinal sections 22, 24 and 26. Outer sections 22 and 26 are non-conductive and may be formed from any suitable non-conductive fiber. These sections preferably contain flame resistant fibers or are coated with a flame resistant material before or after the weaving process. Conductive fibers, such as carbon black or conductive polymer fibers or metallic fibers, yarns or wires (hereinafter referred to as “conductive fibers,” which should be understood to include all such materials), form middle warp section 24. Suitable conductive fiber materials are available under the trademarks METALLINE from Expan of Korea, GORIX from Gorix of Great Britain, and SEIREN from Seiren Company of Japan. Respective wires 28 run between conductive section 24 and each non-conductive section 22 and 26. Wires 28 are woven into the blanket and, in preferred embodiments, are metallic, carbon or polymer fibers of preferably 30-36 gauge. Each wire 28 may comprise a single conductive strand or may include multiple strands or fibers wrapped together.

The loom outputs weft fibers in three parallel transverse sections 30, 32 and 34. Sections 30 and 32 are non-conductive and may be formed from any suitable non-conductive fiber, such as used in warp sections 22 and 26. Conductive fibers, such as the fibers in section 24, form middle weft section 34. Respective sections 32 bound each middle section 34.

The loom outputs a continuous sheet having blanket segments separated by fringe layers 30 that contain little or no weft fibers and at which adjacent blanket segments are cut from each other. The dimensions of any of the warp or weft sections described above may be varied as desired for a given desired blanket size. It should therefore be understood that the illustration in FIG. 4 is not to scale and is provided for purposes of explanation only.

Due to the conductive and non-conductive weave described above, the interwoven conductive warp and weft fibers form a center weave section 36 composed entirely of conductive fibers. Side sections 38 and top and bottom sections 40 include conductive fibers in only one direction, while corner sections 42 include only non-conductive fibers. Accordingly, a voltage drop applied across wires 28 produces a wide area electrical distribution that heats center section 36, while sections 38 and 40, at which minimal current flow occurs, remain relatively unheated.

Referring to FIG. 5, a power plug 44 applies electrical power to wires 28 and may attach through a conventional power cord to a battery pack or a wire and plug unit for attachment to an in-line power source wall receptacle. Lead wires 46 extend from power plug 44 and attach to respective wires 28 through a metal foil blank 48. Each foil blank 48 is sewn into blanket layer 12 or attached by other suitable means, for example ultrasonic welding. The blanket's side selvage areas are then folded over wires 28 and foil blanks 48. The bottom hem is folded over wires 46 and plug 44, and the two selvages and hems are sewn to form the blanket. A hole similar to a shirt button hole is cut in the lower hem at plug 44 for the plug's attachment to a power cord. Alternatively, and prior to attachment of the plug, foam layers may be laminated to either or both sides of layer 12, and oriented fibers may be attached to the foam layers. Following attachment of the plug and wires, the blanket hems enclose the conductor wires and plug.

As should be understood in this art, the plug is typically a custom made injection-molded device. The ends of wires 28 are stripped, and a crimping tool crimps a pair of wire attachments in a jig to the stripped wire ends. An injection molding machine molds a plastic casing about the male ends of the wire attachments so that the resulting plug can receive the power cord's female end.

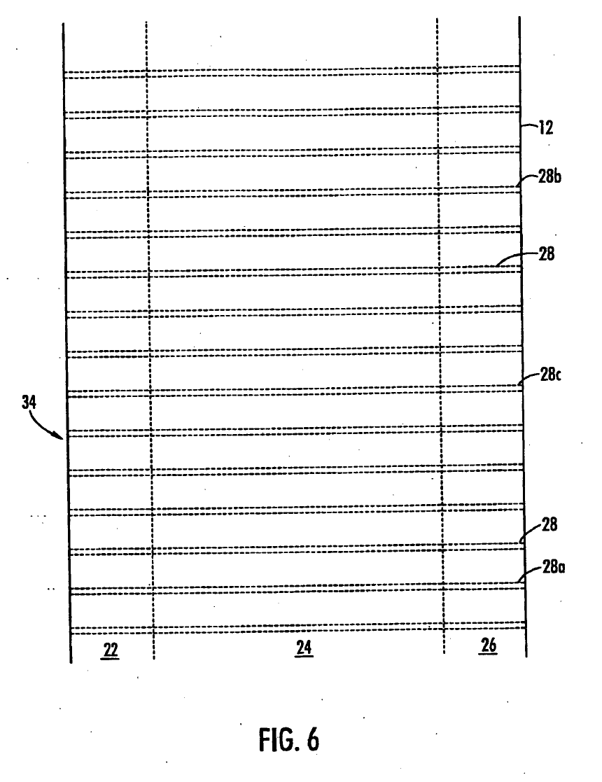

The blanket-forming procedure described above utilizes a predetermined blanket size. Referring to FIG. 6, however, conductive blanket layer 12 may be formed in a roll so that a blanket may be later cut to a desired length. In this embodiment, layer 12 again contains warp fibers divided into conductive center section 24 and two non-conductive side sections 22 and 26. All weft fibers, however, are conductive fibers 34. Wire bundles 28 are disposed at a predetermined interval, for example every six inches, transversely across the layer. As should be understood in this art, looms are capable of inserting wires 28, and the particular weaving procedure is therefore not discussed in detail herein. Blankets of a desired length may be formed by making suitably spaced apart cuts across layer 12. While this results in multiple wires 28 across the blanket, a power plug may be connected through its lead wires as described above to the outermost pair of wires to thereby heat the entire blanket.

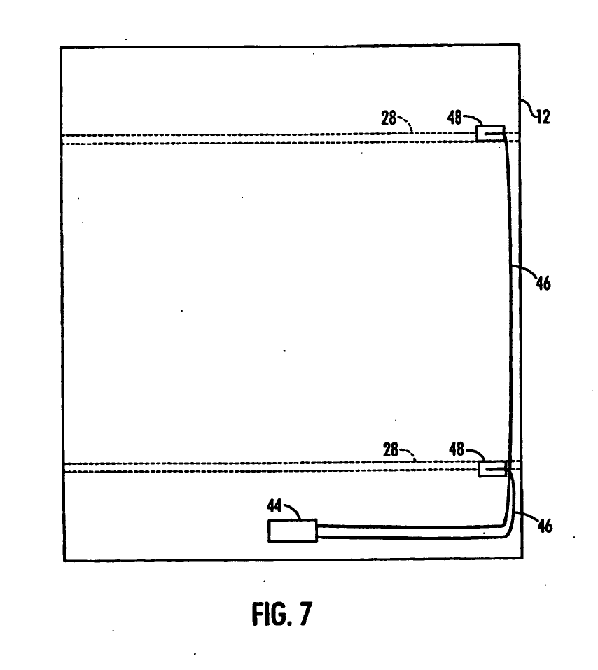

To create a “zoned” blanket, in which different parts of the blanket may be independently controlled to desired heating levels, the blanket may include two sets of power plug/lead wires. For example, where a blanket is cut from conductive blanket layer 12 across the layer outward of wires 28a and 28b, a first power plug applied across wires 28a and 28c forms a first heating zone, and a second power plug applied across wires 28b and 28c defines a second heating zone. Thus, the left and right edges of the blanket sheet as shown in FIG. 6 define the blanket's top and bottom edges when it is used. Referring also to FIG. 7, a hemming area may be left on either side of the outermost wires 28 in which to dispose power plug 44 in a suitable manner. These selvage areas may also include additional wires 28 that are not used for power delivery. That is, wires 28a and 28b are the outermost conductor wires in the blanket, although they are not necessarily the outermost wires in the sheet used to make the blanket.

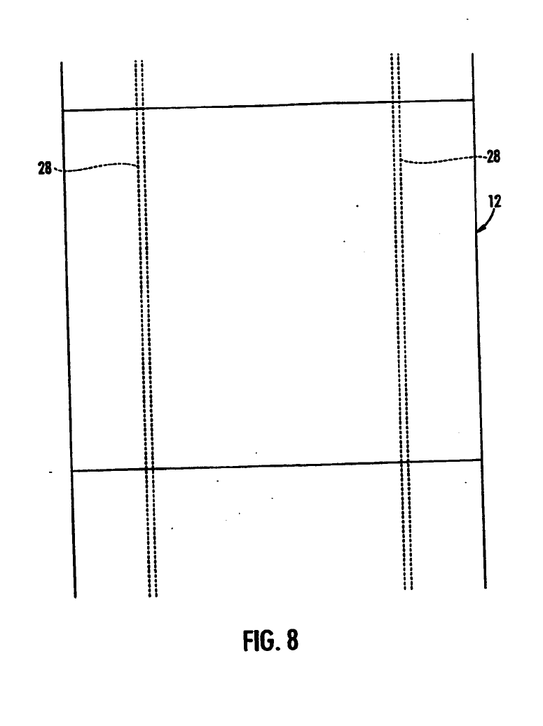

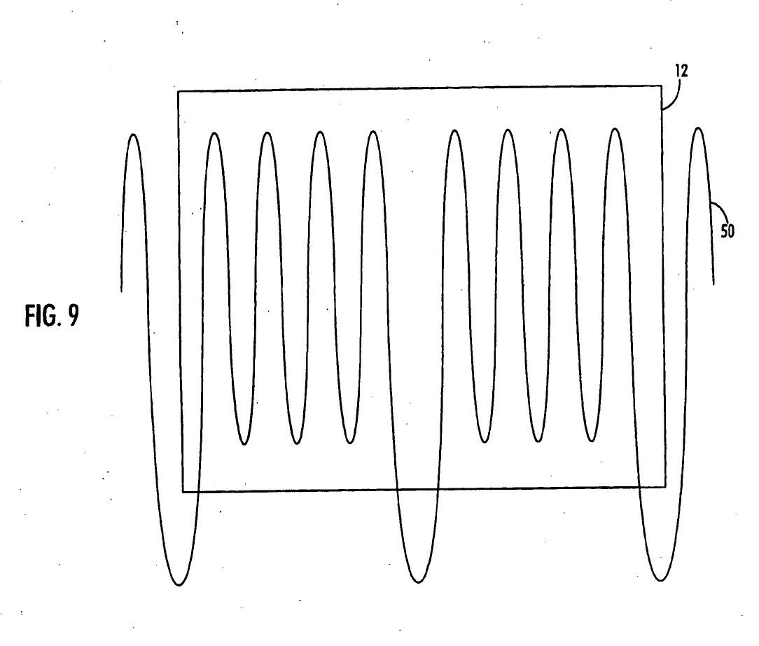

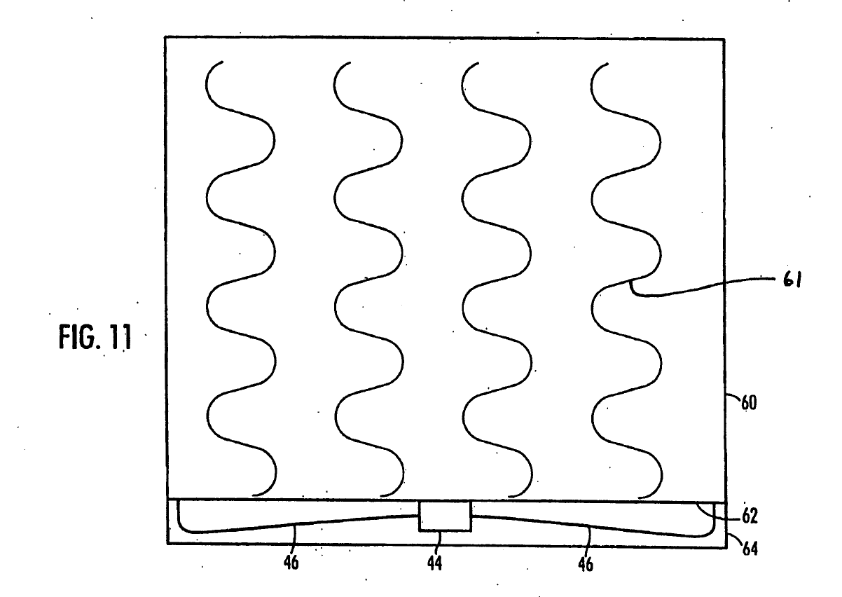

Referring now to FIG. 8, the weft and warp fiber construction of scrim layer 12 is the same as described above with respect to FIG. 6. This embodiment, however, only uses two wire bundles 28, each running longitudinally with the warp as in the embodiment discussed above with respect to FIG. 4. As in the previous embodiment, a blanket may be formed by cutting blanket layer 12 to any desired length. After cutting the layer and forming the blanket, the power plug and lead wires are disposed as shown in FIG. 11, and the power plug is folded or sewn into the hem. Accordingly, the left and right edges of the blanket sheet as shown in FIG. 8 define the blanket's top and bottom edges when it is used. Control circuitry (discussed below) for controlling application of power to the heating element is external of the power plug and is disposed in-line with a power cord extending between a power source, for example batteries or an AC wall power source, and the power plug.

Such power plug/control circuit/lead wire arrangements may also be used with the earlier-described blankets in which a wire heating element is disposed on or in an otherwise non-conductive scrim layer. Referring to FIG. 9, for example, an oscillating dispenser (not shown) deposits a heating element 50 in a serpentine path on scrim layer 12. Periodically, the dispenser loops the wire into and beyond the selvage area to enable the wire's connection to the lead wires of a power plug. If a blanket includes only one heating zone, the dispenser loops the heating element into the selvage area only at the blanket segment edges. For a dual-zone blanket, the dispenser also loops the wire the middle of the blanket segment.

As described above, the feeder may deposit wire 50 onto the scrim layer before or after lamination of the foam layers onto the scrim. The scrim and foam layers are then laminated together, securing the wire in place between the two layers. In another embodiment, however, foam layers are laminated to respective scrim layers before application of the heating element. A wire feeder disposed at the output of the lamination machine deposits the element on one of the two scrim layers, which is then adhered to the other scrim/foam pair so that the heating element is sandwiched between the two scrim layers. In either embodiment, the blanket, which may also include flocked layers of oriented fibers as discussed above, may be formed in a continuous roll and cut into individual sections. In each section, a hem receives the power plug and lead lines. More specifically, the wire loops are cut, power plugs are attached across the cut element ends by lead wires as discussed above, and the plug/lead wires are hemmed into the blanket edges. A hole is cut in the hem to provide access to the plug, and the hole edges are stitched to prevent fraying.

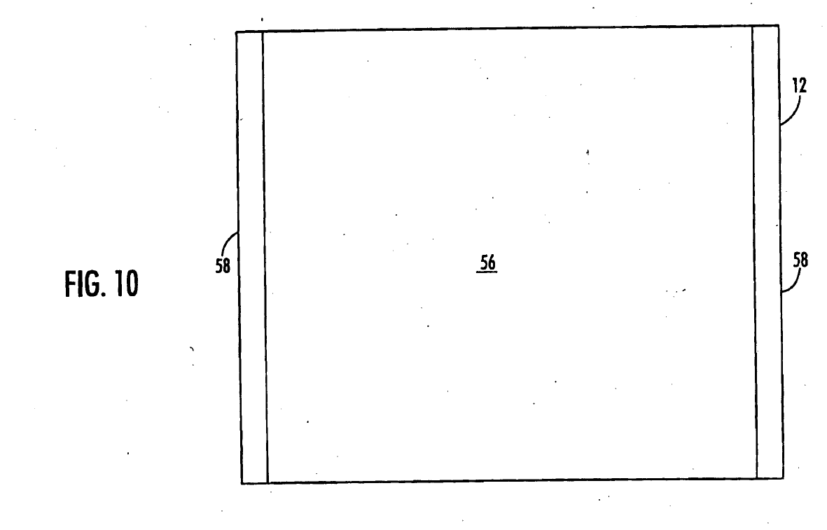

Wired scrim layers as described with respect to FIGS. 2, 3, and 13 (preferably without laminated foam layers and with the heating element attached to the scrim by adhesive or other suitable means)and conductive blanket layers as shown in FIG. 4, may be used to form an electric quilt. The particular arrangement of the heated layer may vary as desired, and it should be understood that the heating element may be disposed on any foundation on which the heating element is accessible to connection to a power source and protected against short circuit and which can be inserted into a quilt cover. Thus, FIG. 10 illustrates a blanket layer 12 defining a heated center section 56 comprising, for example, a wire layer disposed on a foundation layer or a weave of conductive fibers. The wires or fibers extend into selvage areas 58, which carry wire bundles for connection of area 56 to a power source.

FIG. 11 illustrates a comforter bag 60 made in any conventional manner. The bag includes top and bottom sides sewn on three edges so that the bag opens at the fourth edge. The bag receives layer 12 (FIG. 10), along with any suitable batting, through the open edge 62. Preferably, the batting is inserted first. As should be understood in this art, batting may comprise any suitable filler material, for example a web of soft bulky, usually carded, fibers. In one preferred embodiment, the batting is cut from a continuous non-woven polyester sheet.

The heating element, on a scrim or other substrate or as part of a conductive weave, is inserted on top of the batting. Alternatively, an unattached heating element wire may be pushed into the quilt by a tool having one or more elongated fingers that push the heating element into the quilt bag, leaving the heating element in successive loops on the batting when the tool is removed. The batting and scrim are both preferably non-flammable or self-extinguishing. Lead wires 46 are attached to the heating element through open edge 62, and wires 46 and power plug 44 are folded or sewn into the quilt by a selvage section 64 as open edge 62 is closed. The bag is then flipped over, so that the heating element is below the batting, and a quilt pattern 61 is sewn through the quilt. A mechanical or electrical attachment skips the sewing head over the heating element in the quilt.

A quilt may also be formed by sewing a non-heated blanket layer, made from a weave, a scrim-based blanket or any desired blanket material, to a heated blanket along three of the blankets layers' edges, thereby forming a bag with an open edge.

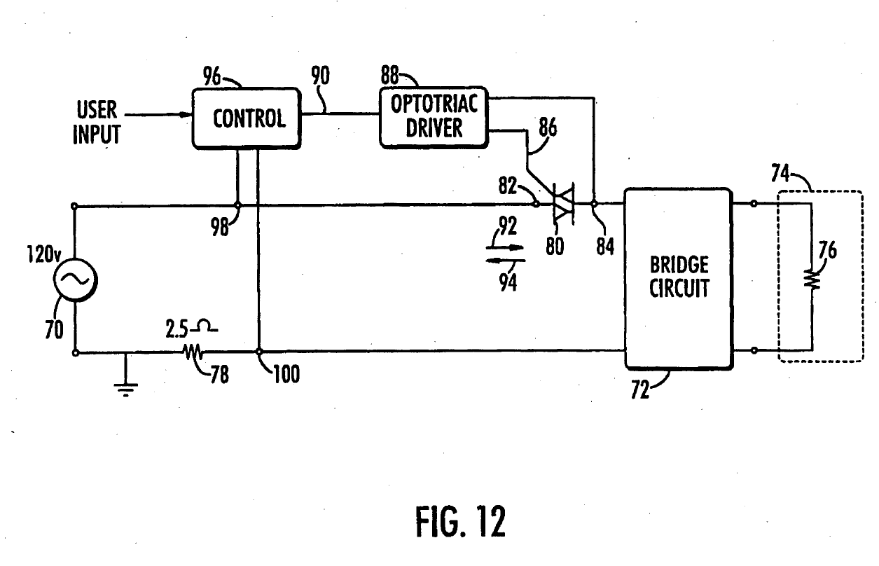

FIG. 12 shows a schematic illustration of a control circuit for use with any generally planar spread, indicated in phantom at 74. The control circuit manages the heating element's temperature and detects shorts, opens and partial shorts in the heating element. The heating element is incorporated in the spread and is indicated at 76 as a resistance. The resistance may represent a heating element in any suitable heated, generally planar spread such as a blanket, quilt, heating pad, and mattress pad. It should be understood that the term “mattress pad”, as commonly used in the bedding industry, includes mattress pads ranging from thin, felt-backed mattress pads to quilted mattress pads filled with at least one layer of sheeting or batting to thick “pillow top” mattress pads filled with a significantly greater amount of pillow fill material. Further, the heated spread of the present invention includes both removable, heated mattress pads, non-removable heated mattress pads integrated as an upper layer of a mattress construction, and all semi removable/non-removable hybrids thereof. Sheets, including non-woven sheets, plastic sheets, polymer blend sheets, and rubber sheets are also considered “spreads” for the present invention. The term “electric blanket” as used herein with respect to the control circuit should be understood to include all such spreads.

A 120 volt AC voltage source 70 powers the heating element through a full-wave bridge rectifier 72, a sampling resistor 78 and a triac switch 80. As should be understood by those skilled in this art, a triac switch conducts AC current between inputs 82 and 84 in both directions as long as an activating signal is present on a control lead 86. If the activating signal is discontinued, the triac conducts current until the input signal's next zero crossing.

The activating signal is provided by an optically isolated triac driver 88 that acts as a switch passing current from node 84 to the control lead 90. Thus, when driver 88 is activated by its control lead 90, the signal from source 70 drives triac 80. During this signal's positive cycle portion, current travels through triac 80 in the direction indicated by arrow 92. During its negative cycle position, current travels through the triac in direction 94.

A control circuit 96 controls driver 88. Control circuit 96, for example comprising a single integrated circuit (IC), may include a microprocessor and an A/D converter. Through the converter, the IC receives voltage measurements from nodes 98 and 100. The measurement from node 100 is the voltage across sampling resistor 78. Thus, the controller may determine the current through heating element 76 by dividing the voltage measured at 100 by the known resistance of sampling resistor 78. The voltage applied to the system is measured at 98. Thus, the system's total resistance is equal to the voltage measured at 98 divided by the current measured at 100. The resistance of heating element 76 may therefore be determined by backing out the known resistances of the components upstream from the heating element.

As discussed above, the temperature of heating element 76 is related to its resistance. Wire manufacturers typically rate wire resistance with respect to a predetermined temperature, generally around 75 degrees Fahrenheit. The manufacturer also typically provides the wire's temperature coefficient. Thus, given a known length L of heating element 76 having a temperature coefficient TC and a rated resistance X (in ohms per unit length) at Y .degree. Fahrenheit, and given a measured resistance Z (in ohms) between nodes 98 and 100 as discussed above, heating element temperature T=Y+(1/XL) (Z−XL)/TC.

The variables Y, TC, X and L are known and may be stored in memory associated with control circuit 96. Therefore, upon determining the measured resistance Z, the control circuit may determine the heating element's temperature T by the equation above. Alternatively, temperature T may be calculated over a range of resistances Z to create a table relating temperature to measured resistance. The table may then be stored in the control circuit's memory so that the control circuit, upon determining an actual measured resistance between nodes 98 and 100, may determine temperature T by reference to the table.

The control circuit 96 may be disposed in a suitable housing attached to or within spread 74, for example in-line with a power cord between the power source and the heating element in the examples discussed above with respect to FIGS. 1-11 and 13. The control circuit may be configured for use with several different heating elements, whether of a wire, woven fiber or other suitable type, each having a range of possible measured resistances Z that does not overlap the range of any of the other heating elements. Thus, the measured resistance Z identifies which heating element the spread contains, and the control circuit can then determine temperature T from the temperature coefficient TC and nominal temperature Y for that heating element or from a lookup table for that heating element.

Control circuit 96 manages the heating element temperature by various methods. Generally, however, the heating element's heat output varies predictably with current. Since triac 26 controls the amount of current passing through the heating element, the element's heat output may be determined by controlling the ratio of the triac's on-time to its off-time based on some predetermined scale. Various control methods are described in Applicant's U.S. Pat. No. 6,222,162, the entire disclosure of which is incorporated by reference herein.

In normal operation, control circuit 96, driven by its microprocessor, may manage spread temperature to a target temperature in a direct relationship to the heating element's measured resistance. Since a rise in measured resistance, and a drop in measured current, reflects a rise in temperature, the control circuit generally reduces current flow to the spread responsively to a resistance increase, or current decrease, reflecting that the spread's temperature is rising beyond the target temperature. Similarly, the control circuit reduces current flow to the heating element responsively to a measured resistance decrease, or current increase, reflecting that the spread's temperature is falling beyond the target temperature.

The control circuit also responds, however, to conditions in which the normal relationships of current and resistance to temperature don't hold, such as opens, drastic shorts and partial shorts in the heating element. For example, while shorts may result in temperature increases, they also exhibit resistance decreases and current increases. A “drastic” short is a short circuit over a major portion of the heating element that causes a current increase significantly beyond a safe operating range. Accordingly, the control circuit stores a threshold resistance value that reflects the occurrence of a drastic short, and the control circuit disconnects the spread's power when the measured resistance falls below this threshold. The particular threshold value depends on the heating element's characteristics, as should be understood by those skilled in the art. In a spread having a typical heating element resistance of 100 ohms, however, the control circuit disconnects power upon detecting a resistance of 80 ohms or less.

Similarly, in another preferred embodiment, the control circuit disconnects the spread's power when the current measured at 100 rises above a predetermined level. In a spread having a typical current level of 1.1 amps, for example, control circuit disconnects power upon detecting a current level of 1.25 amps or more.

Heating elements are relatively long, and they may therefore be subject to “partial” shorts—short circuits across a limited portion of the element that produce a current increase relatively smaller than that of a drastic short. In particular, partial shorts may increase current to within a range experienced normally when the spread is cold. The control circuit detects partial shorts, and differentiates them from a normal cold condition, based on the rate of change in the element's resistance or current. When the element's resistance or current changes due to acceptable temperature fluctuation, the change takes a relatively long time. For example, wire made from 34 gauge cadmium copper alloy takes thirty seconds or longer to change from 45 degrees C. to 49 degrees C., corresponding to a resistance change from 176.2 ohms to 178.8 ohms and a current change of 0.624 amps to 0.615 amps. Thus, assuming that this temperature change is acceptable, the control circuit should not interpret a 2.6 ohms or a 0.007 amp change over a thirty second period to indicate a partial short. The circuit does recognize a partial short, however, if such a resistance or current change occurs within a period less than that acceptable for normal temperature fluctuations. The definition of this time period depends on operational factors such as the heating element's materials and dimensions. In one embodiment, for example, where a heating element is a 34 gauge cadmium copper alloy wire, the control circuit disconnects power to the heating element if there is a 0.5 ohms resistance decrease or 0.002 amp current increase, or greater, from one current cycle to the next. Of course, other arrangements may be suitable under different circumstances. PTC wire, for example, has a relatively high temperature coefficient, and it's resistance may change relatively quickly without being subject to a short. In this instance, the control circuit may be configured to disconnect heating element power if the processor detects a cycle-to-cycle resistance change of 2 ohms or more or a current change of 0.025 amps or more.

The control circuit also disconnects heating element power if it detects an open in the heating element. In a preferred embodiment, the control circuit disconnects power if it senses that the heating element's resistance is at or above, or if the current level is at or below, a threshold level that is sufficient to indicate an open has occurred. The particular threshold value for a particular heating element will depend on the element's characteristics. In one example, however, in which the heating element normally exhibits a 100 ohms resistance and 1.1 amp current, the control circuit disconnects heating element power upon detecting a resistance of 200 ohms or greater or a current of 0.55 amps or lower.

Accordingly, a measured resistance or current outside ranges that would be expected during normal operation may indicate an open or a partial or drastic short, and the control circuitry disconnects electricity flow to the heating element. Abrupt up or down resistance or current changes may also indicate these conditions, and the control circuitry therefore also disconnects power responsively to the rate at which these parameters change.

The heating circuit described above is useful in another preferred embodiment of the present invention as shown in FIG. 14 where the electric blanket or spread wherein the spread is a mattress pad 100. As an example of construction for the simplest type of mattress pad, a heating element wire 18 is enclosed in a 1- to 2-inch wide strip of fabric and attached to a polyester substrate sheet 103, preferably an insulative material, by sewing a desired heating pattern on the sheet thus forming a channel about the heating element. The substrate sheet is adhered to a felt pad or other such high-friction fabric 102 suitable for securing the position of the mattress pad on the upperside of a mattress. The upper side of the substrate sheet may be covered with a “topper” 104 for added comfort and heat dispersion. A plug 107 suitable for providing communication between the heating element and a power source 70 is inserted in an open end of the channel and attached to the end of the heating element, with the controller system of the present invention positioned in series between the power source and the heating element. Nylon stretch material can then be sewn on each side of the sheet to provide a means for removably securing the mattress pad across the sleeping surface of the mattress. The topper 104 can be selected from polyester and cotton sheeting, or a quilted top with a layer of fiber fill. A thicker layer of fiber fill or pillow fill provides the pillow-top mattress pad. The control is the same as described above for electric blanket controls.

In still another embodiment of the present invention, the electric spread is not a throw-type spread as in the previous examples, but rather a fixed component of a multi-layered pillow-top mattress assembly 105. The pillow-top mattress pad 100 portion of a pillow-top mattress appears to be separate from the mattress core 114 but is not separate because corners are formed at the top of the mattress border, and at the bottom of the pillow top mattress pad border, so that a neck is formed in the material. In profile, there is a V-shaped indentation at the mattress-pillow interface as shown in FIG. 15. Although sewn together, the pillow top and the mattress core components are-and appear to be-distinct, being made from separate pieces of cloth and padding. U.S. Pat. No. 6,874,215 B2, issued Apr. 5, 2005 to Flippin, incorporated herein in its entirety, discloses several examples of methods for making pillow top mattresses.

The electric pillow-top mattress 105 of the present invention is built around a mattress core 114. The mattress core includes an inner spring assembly comprising an array of coil springs, covered top and bottom by pads of felt or other material. Alternatively, the core may be made of foam, or closed chambers containing water or air, or any combination thereof as is described by Flippin, and including other cores known in the mattress art. In the electric pillow-top mattress, an elongated heating element as described above extends across the upper surface of the mattress core in a pattern, thereby forming a heating layer above the mattress core. A regulator is in electrical series between the heating element and the power source as described in the electric spreads above. An insulating layer of fill material is disposed above the heating layer. A fabric cover 106 envelopes the mattress core, the heating layer, and the insulating layer together in a fashion so as to provide a mattress having a pillow-top component having its own padding, distinct from that of the mattress core. It should be understood that, while preferred, the mattress of the present invention does not necessarily have to have a V-shaped indentation at the mattress-pillow interface.

The regulator circuit of the electric pillow-top mattress is in communication with the heating element electrically between the power source and the heating element. The regulator circuit is configured to measure rate of change in the heating element of at least one of the heating element's resistance and the heating element's current and to control delivery of electricity from the power source to the heating element responsively to the rate of change. The regulator circuit preferably includes the resistive element as described in series between the power source and the heating element and a processor in communication therewith for regulating the electric current supplied to the heating element based on the resistance associated with the resistive element. The regulator mechanism of the electric pillow-top mattress of the present invention can be based on any known heat regulation system suitable for electric blankets and other such bedding. Examples of such known suitable heating regulator mechanisms that can be used in the electric mattress of the present invention may be found in U.S. Pat. Nos. 4,658,119; 3,543,005; 2,794,896; 4,656,334; 4,633,062; 5,441,476; 4,162,393; 6,770,854; 4,132,262; 3,668,367 the disclosures of which are each included herein by reference.

The invention has been described in detail with particular reference to preferred embodiments thereof, but it will be understood that variations and modifications can be effected within the spirit and scope of the invention.

1. A mattress pad, said mattress pad comprising: an elongated heating element strand extending through said mattress pad so that, upon receiving electric current from a power source, said element heats said mattress pad; and a regulator circuit in communication with said heating element electrically between said power source and said heating element, wherein said regulator circuit is configured to measure rate of change in said heating element of at least one of said heating element's resistance and said heating element's current and to control delivery of electricity from said power source to said heating element responsively to said rate of change.

2. The mattress pad as in claim 1, wherein said rate of change is a rate of change of the resistance of said heating element and wherein said regulator circuit is configured to measure said resistance rate of change.

3. The mattress pad as in claim 1, wherein said rate of change is a rate of change of current flowing through said heating element and wherein said regulator circuit is configured to measure said current rate of change.

4. The mattress pad as in claim 1, wherein said mattress pad is permanently fastened across a mattress.

5. The mattress pad as in claim 1, wherein said mattress pad is semi-permanently fastened across a mattress.

6. The mattress pad as in claim 1, wherein said mattress pad is adapted for being removably spread across a mattress.

7. The mattress pad as in claim 1, wherein said mattress pad is a pillow-top mattress pad.

8. The mattress pad as in claim 1, wherein said elongated heating element is affixed to a sheet.

9. An electric mattress, comprising:
a mattress core having an upper surface;
an elongated heating element extending across the upper surface of said mattress core in a pattern and configured to generate resistive heat upon receiving electric current from a power source thereby forming a heating layer above said mattress core;
a regulator circuit in communication with said heating element electrically between said power source and said heating element, wherein said regulator circuit is configured to measure rate of change in said heating element of at least one of said heating element's resistance and said heating element's current and to control delivery of electricity from said power source to said heating element responsively to said rate of change so as to provide heat to said sleeping surface;
an insulating layer of fill material disposed above said heating layer; and
a fabric cover enveloping said mattress core, said heating layer, and said insulating layer together and defining a channel adapted for providing electrical communication between said power source and said heating element.

10. The electric mattress as in claim 9, further comprising a cushioning layer between said mattress core and said heating layer.

11. The electric mattress as in claim 9, further comprising a pillow layer above said insulating layer.

12. The electric mattress as in claim 9, wherein said elongated heating element is affixed to a sheet spread across said mattress core.

13. The electric mattress as in claim 9, wherein said rate of change is a rate of change of the resistance of said heating element and wherein said regulator circuit is configured to measure said resistance rate of change.

14. The electric mattress as in claim 9, wherein said rate of change is a rate of change of current flowing through said heating element and wherein said regulator circuit is configured to measure said current rate of change.

15. An electric mattress, said mattress comprising:
a mattress core having an upper surface;
an elongated heating element extending across the upper surface of said mattress core in a pattern and configured to generate resistive heat upon receiving electric current from a power source thereby forming a heating layer above said mattress core;
an insulating layer of fill material disposed above said heating layer;
a regulator circuit including a resistive element disposed in series between said power source and said heating element;
a processor in communication with said power source and said resistive element and configured to measure current through said resistive element, to determine a resistance associated with said heating element responsively to a power source voltage and said resistive element current and to control delivery of electricity from said power source to said heating element based upon said resistance associated with said heating element; and
a fabric cover enveloping said mattress core, said heating layer, and said insulating layer and being adapted for providing electrical communication between said power source and said heating element.

16. The electric mattress as in claim 15, further comprising a cushioning layer between said mattress core and said heating layer.

17. The electric mattress as in claim 15, further comprising a pillow layer above said insulating layer.

18. The electric mattress as in claim 15 wherein said processor is configured to control delivery of electricity from said power source to said heating element based upon a predetermined change in at least one of said resistance and said resistive element current over a predetermined increment of said electric current from said power source.
